(19) United States
(12) Patent Application Publication
(10) Pub. No.: US 2021/0094789 A1
(43) Pub. Date: Apr. 1, 2021

(54) PADDLE DEVICES, AND FINISHER DEVICES AND IMAGING APPARATUSES EMPLOYING THE SAME

(71) Applicant: HEWLETT-PACKARD DEVELOPMENT COMPANY, L.P., Spring, TX (US)

(72) Inventors: Heungsup PARK, Pangyo (KR); Haseog JO, Pangyo (KR); Taehong KIM, Pangyo (KR); Sooncheol JEONG, Suwon (KR)

(73) Assignee: HEWLETT-PACKARD DEVELOPMENT COMPANY, L.P., Spring, TX (US)

(21) Appl. No.: 17/044,818

(22) PCT Filed: May 14, 2019
(86) PCT No.: PCT/US2019/032186

§ 371 Date: Oct. 1, 2020

(30) Foreign Application Priority Data
May 15, 2018 (KR) 10-2018-0055680
Jan. 18, 2019 (KR) 10-2019-0006569

(51) Int. Cl. B65H 31/38; B41J 13/10

(52) U.S. Cl. CPC B65H 31/38; B65H 2404/73; B41J 13/106

(57) ABSTRACT

A paddle device for a finisher device to align paper discharged from an imaging apparatus comprises a paddle drive shaft to be rotated by a paddle motor, a rotation body having an installation hole, through which the paddle drive shaft is fitted into the rotation body, and a paddle blade extending from the rotation body and having an end portion that is to contact the paper while the paddle drive shaft is rotated by the paddle drive shaft, to align the paper.

### BACKGROUND

Imaging apparatuses, such as printers, copy machines, facsimile machines, and multifunctional apparatuses that incorporate these, perform a function of printing or copying text, and recently there has been a trend in which such apparatuses are incorporated with various other apparatuses, thus being capable of performing various additional functions.

For example, in the past, a user performed operations such as stapling or punching by separately using a device such as a stapler or a punch in a state in which directly discharged sheets of paper are aligned by a user. In recent years, however, there has been an increasing trend toward the installation of finisher devices in printers, copy machines, and the like, such that these finisher devices integrally perform operations such as stapling, punching, and the like.

A general finisher device includes a paddle for aligning sheets of paper discharged from a printer, a copy machine, or the like. That is, a finisher device installed in a printer, a copy machine, or the like performs a paddling operation using a paddle to align sheets of paper being discharged from a printer, a copy machine, or the like. Paddle blades made of rubber perform a paddling operation while rotating by being driven by a paddle motor.

### BRIEF DESCRIPTION OF THE DRAWINGS

FIG. 1 is a schematic configurational view of an example of an inkjet printer in which a paddle device according to an example of the present disclosure may be installed.

FIG. 2 is a partial perspective view of a paddle device installed in a finisher device of an inkjet printer, according to an example of the present disclosure.

FIG. 3 is a partial perspective view illustrating a portion of a paddle device according to an example of the present disclosure.

FIG. 4 is a graph for defining a temperature at which an inflection point of storage modulus G′ appears, a temperature at which a peak point of loss modulus G″ (unit: MPa) appears, and a temperature at which a peak point of tan δ appears.

FIG. 5 illustrates results of measuring changes in paddle force (normal force) applied to end portions of paddle blades of Examples 1 to 3 and Comparative Examples 1 to 6 over time.

FIG. 6 illustrates decreases in paddle force (normal force) applied to end portions of the paddle blades of Examples 1 to 3 and Comparative Examples 1 to 6 over time.

FIG. 7 is a graph in which changes in compiling force according to an increase in the number of rotations of a paddle for the paddle blade of Example 1 are recorded.

### DETAILED DESCRIPTION

In this regard, the paddling operation is an operation of pulling paper discharged from a paper discharge roller by friction between paddle blades and the paper which occurs when the paper is hit by rotating paddle blades, and transferring the paper to a backstop located at a rear portion of a tamper base. In the paddling operation, it is to transfer paper to a backstop by snatching the paper using a frictional force between paddle blades and the paper when the paper falls by its own weight. Sheets of paper discharged through such an alignment operation are sequentially placed on a paper discharge tray. However, rubber paddles currently used in finisher devices have been developed to be suitable for use in laser-printing-type electrophotographic imaging apparatuses and are made of a paddle material that is suitable for use in a case in which output materials have a high coefficient of friction. When these rubber paddles are used in inkjet-type imaging apparatuses, the content of moisture in paper is high as compared to paper printed using a laser printing method; as a result, frictional force is not sufficiently high, such that misalignment or jamming of paper is likely to occur in a finishing process. Hereinafter, a printer will be described as an example of an imaging apparatus, but the imaging apparatus may be any device capable of performing an image forming operation, such as a printer, a scanner, a facsimile machine, a multi-function printer (MFP), a display device, or the like. The imaging apparatus may be an inkjet-type imaging apparatus.

Hereinafter, a paddle device for a finisher device, according to some examples of the present disclosure, and an imaging apparatus including the paddle device will be described in detail with reference to the accompanying drawings, in such a way that the present disclosure may be carried out by one of ordinary skill in the art to which the present disclosure pertains, without undue difficulty. However, the present disclosure may be in many different forms and is not limited to the examples described herein.

A paddle device for a finisher device, according to some examples of the present disclosure, and an imaging apparatus including the paddle device will be described in detail.

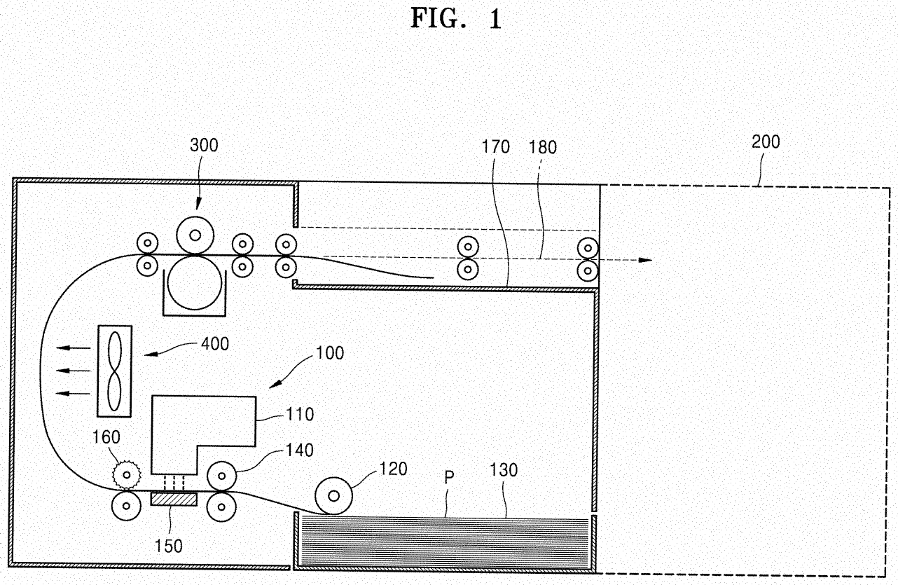

FIG. 1 is a schematic configurational view of an example of an inkjet printer in which a paddle device according to an example of the present disclosure may be installed. Referring to FIG. 1, the inkjet printer may include an image forming unit 100 configured to form an image on paper P by ejecting a liquid, for example, ink thereonto. The image forming unit 100 may include an inkjet head 110. The inkjet head 110 may include an ink tank in which ink is accommodated. The ink tank may be detached from the inkjet head 110, and may be connected to the inkjet head 110 via a connecting member, such as a pipe or the like, to thereby supply ink to the inkjet head 110.

The inkjet head 110 may be a shuttle-type inkjet head configured to eject ink onto the paper P moving in a sub-scanning direction while reciprocating in a main scanning direction. The inkjet head 110 may also be an array inkjet head that has a length in a main scanning direction corresponding to a width of the paper P and ejects ink onto the paper P moving in a sub-scanning direction at a fixed position without moving in a main scanning direction. By employing the array inkjet head, high-speed printing is possible, as compared to a case in which a shuttle-type inkjet head is employed.

The inkjet head 110 may be, for example, a monochromatic inkjet head configured to eject ink with a black color. The inkjet head 110 may be, for example, a color inkjet head configured to eject ink of black (K), yellow (Y), magenta (M), and cyan (C) colors.

The paper P discharged by a pickup roller 120 from a paper feed cassette 130 is transferred by a feed roller 140 in a sub-scanning direction. The paper P is supported by a platen 150 such that the paper P is maintained at a predetermined distance from the inkjet head 110. The inkjet head 110 ejects ink onto the paper P, thereby forming an image on the paper P. The paper P is transferred by the feed roller 160. Ink on the paper P having reached the feed roller 160 has not yet been dried, and thus when the feed roller 160 comes into surface contact with an image surface of the paper P, an image may be smudged or contaminated. The feed roller 160 may have a structure capable of preventing image smudging. For example, the feed roller 160 may include a pair of rollers that are engaged with each other, and one of the rollers that is located on an image surface side of the paper P may come into point contact with the image surface. The paper P is discharged to a paper discharge tray 170.

When ink is ejected onto the paper P, the ink permeates into the paper P. At this time, curling may occur on the paper P. In addition, when moisture having permeated into the paper P is not completely removed, a surface of the paper P may become rough. Thus, the paper P may not be loaded evenly on the paper discharge tray 170. For example, in a case in which the surface of the paper P is rough or curled, when a next sheet of paper P (second medium) is discharged on a previously discharged sheet of paper P (first medium), the first medium may be pushed by the second medium.

The inkjet printer may further include a fixing unit 300 depending on the type of an inkjet print head. The fixing unit 300 may flatten the curl of the paper P by applying heat and pressure to the paper P on which an image is printed, thereby smoothing-out the paper P, and, at the same time, may almost completely remove moisture in the paper P, thereby reducing surface roughness of the paper P. Accordingly, high-speed printing of the inkjet printer is possible, and operation reliability of a finisher device 200 may be enhanced.

When a printing speed is increased, the time for drying ink on the paper P between the image forming unit 100 and the fixing unit 300 may not be secured. Thus, the inkjet printer may further include, between the image forming unit 100 and the fixing unit 300, a drying device 400 configured to dry ink on the paper P, depending on the type of an inkjet print head. The drying device 400 may be a non-contact type drying device that is not in contact with the paper P. For example, the drying device 400 may dry ink on the paper P by supplying air to the paper P discharged from the image forming unit 100. The drying device 400 may include an air blower.

The inkjet printer further includes the finisher device 200. The paper P is transferred along a paper discharge path 180 to be sent to the finisher device 200. The finisher device 200 includes a paddle device configured to align the discharged sheets of paper P on which an image is printed. The finisher device 200 may include a stapler capable of stapling the aligned sheets of paper P, a punch capable of perforating the aligned sheets of paper P, or the like. The finisher device 200 may also include a paper folding device that folds the paper P one or more times. The paper P discharged from the inkjet printer has a high content of moisture therein, as compared to a case in which printing is performed using a laser printer. Such a high moisture content tends to reduce operation reliability when operations such as alignment, compiling, punching, stapling, and the like are performed using the finisher device 200. The curled and rough surface of paper may also affect the operation reliability of the finisher device 200.

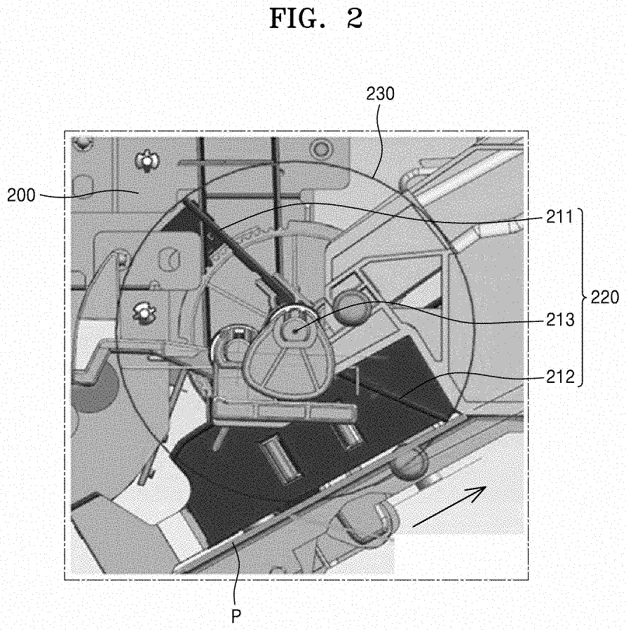

FIG. 2 is a partial perspective view of a paddle device 220 installed in the finisher device 200 of an inkjet printer, according to an example of the present disclosure.

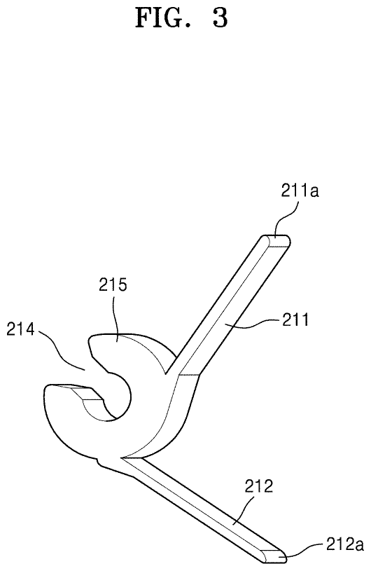

Referring to FIGS. 2 and 3, the paddle device 220 includes a paddle drive shaft 213 that is rotated by driving of a paddle motor (not shown), a rotation body 215 having at its center an installation hole 214 through which the paddle drive shaft 213 is fitted into the rotation body 215, and paddle blades 211 and 212 that respectively include end portions 211a and 212a that come into contact with the paper P being transferred in an arrow direction while being rotated by the paddle drive shaft 213 to align sheets of paper. The paddle device 220 performs a paddling operation using the paddle blades 211 and 212 to align sheets of paper discharged from the inkjet printer. The paddle blades 211 and 212 made of rubber perform a paddling operation while rotating along a rotation circle 230 illustrated in FIG. 2. In this regard, the paddling operation is an operation of pulling paper using a frictional force between the paddle blades 211 and 212 and the paper P, which occurs when the paddle blades 211 and 212 being rotated hit the paper P discharged from the inkjet printer, and transferring the paper P to a backstop (not shown) located on a rear side of a temper base (not shown). In the paddling operation, it is important to transfer the paper P to a backstop by snatching the paper P using a frictional force between a paddle and the paper P when the paper P is dropped by its own weight. Sheets of paper discharged through such an alignment operation are sequentially stacked on a paper loading tray (not shown).

FIG. 3 is a partial perspective view illustrating a portion of the paddle device 220 according to an example of the present disclosure. In FIG. 3, the rotation body 215 having at its center the installation hole 214 that defines an empty space through which the paddle drive shaft 213 (see FIG. 2) is inserted, and the paddle blades 211 and 212 that extend outward from the rotation body 215 and respectively include the end portions 211a and 212a that come into contact with the paper P. The paddle blades 211 and 212 may be rotated by the paddle drive shaft 213 (see FIG. 2) acting as a rotating shaft.

Since the paper P discharged from the inkjet printer has a high moisture content as compared to a case in which printing is performed using a laser printer, when operations such as alignment, compiling, punching, stapling, and the like are performed using general paddle blades developed for a laser printer, operation reliability may be reduced.

In the paddle device 220 according to the present disclosure, however, the paddle blades 211 and 212 use a polyurethane or a polyurethane composition which is controlled to have specific mechanical and viscoelastic properties, and thus even when used in an inkjet-printing-type imaging apparatus, operations such as alignment, compiling, punching, stapling, and the like may be stably performed for a long period of time.

In particular, in the present disclosure, physical properties of paddle blades are controlled overall based on: mechanical properties including a normal load variation and an amount of deformation after a certain time period has elapsed; and viscoelastic properties including a storage modulus, a loss modulus, and a tan δ value. More particularly, in a case in which the paddle blades 211 and 212 have a thickness of about 1 mm to about 4 mm, when an initial normal load of about 10 gf to about 15 gf is applied to the end portion of the paddle blade in a direction perpendicular to the end portions 211a and 212a of the paddle blades 211 and 212, a variation in normal load applied thereto as time elapses may be about 0.03 gf/hr or less after 70 hours has elapsed. The normal load variation may also be approximately obtained by dividing, by 70 hr, a value obtained by subtracting a normal load (unit: gf) applied in a direction perpendicular to the end portions 211a and 212a of the paddle blades 211 and 212 at a time of 70 hours (t=70 hr) from an initial (t=0 sec) normal load (unit: gf) applied in a direction perpendicular to the end portions 211a and 212a of the paddle blades 211 and 212. The normal load variation may be, for example, about 0.03 gf/hr or less, about 0.029 gf/hr or less, about 0.028 gf/hr or less, about 0.027 gf/hr or less, about 0.026 gf/hr or less, about 0.025 gf/hr or less, about 0.023 gf/hr or less, about 0.024 gf/hr or less, about 0.023 gf/hr or less, about 0.022 gf/hr or less, or about 0.021 gf/hr or less, when the paddle blades have a thickness of about 1 mm to about 4 mm, for example, about 1 mm to about 3 mm, about 2 mm to about 3 mm, 2 mm, or 1.8 mm. When the normal load variation is increased, a normal force acting on the surface of paper when the paddle blades pull the paper becomes weaker, and thus it is difficult to align sheets of paper.

When the paddle blade is repeatedly rubbed against a surface of paper by making the paddle blade rotate at a speed of 1,600 pulses per second (pps) or 6,000 pps two or three times within 2.41 seconds while the initial normal load of about 10 gf to about 15 gf is applied to the end portion of the paddle blade, the amount of deformation of the end portions of the paddle blades after 70 hours has elapsed may be about 2 mm or less. The amount of deformation of the end portions of the paddle blades may be, for example, about 2 mm or less, about 1.9 mm or less, about 1.8 mm or less, about 1.7 mm or less, about 1.6 mm or less, about 1.5 mm or less, about 1.4 mm or less, about 1.3 mm or less, about 1.2 mm or less, about 1.1. mm or less, about 1.0 mm or less, about 0.9 mm or less, about 0.8 mm or less, about 0.7 mm or less, about 0.6 mm or less, about 0.5 mm or less, about 0.4 mm or less, about 0.3 mm or less, about 0.2 mm or less, or about 0.1 mm or less. When the amount of deformation of the end portions of the paddle blades is increased, a normal force acting on the surface of paper when the paddle blades pull the paper, i.e., a frictional force or a pulling force acting on the paper, becomes weaker, and thus it is difficult to align sheets of paper.

In a measurement test performed on the paddle blades 211 and 212 through dynamic mechanical analysis using a free damped oscillation method, which is conducted as a function of temperature at a temperature ranging from about −100° C. to about 100° C. in a nitrogen atmosphere and at a measurement frequency of 10 Hz, a heating rate of 2.0° C./min, and an initial strain of 0.03%, a temperature at which an inflection point of storage modulus G′ (unit: MPa) appears may be in a range of about −35° C. to about 30° C., a temperature at which a peak point of loss modulus G″ (unit: MPa) appears may be in a range of about −30° C. to about 25° C., and a temperature at which a peak point of tan δ appears may be in a range of about −30° C. to about 30° C.

In this regard, the storage modulus G′ and the loss modulus G″ satisfy the relationships of complex modulus of elasticity G*=G′+iG″ and tan δ=G″/G′, and δ refers to an angle of G* with respect to a real axis in a complex plane.

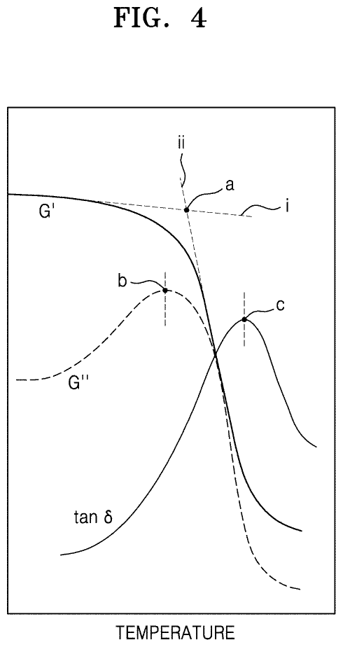

FIG. 4 is a graph for defining a temperature at which an inflection point of storage modulus G′ appears, a temperature at which a peak point of loss modulus G″ appears, and a temperature at which a peak point of tan δ appears.

In this regard, as illustrated in FIG. 4, the temperature at which an inflection point of storage modulus G′ appears refers to a temperature at a point (a) at which a virtual straight line (i) plotted on a storage modulus G′ curve measured as a function of temperature at a low-temperature region intersects with a virtual straight line (ii) plotted at a middle-temperature region where the storage modulus G′ curve is sharply decreased as the temperature increases. Here, the virtual straight line (i) is a virtual curve plotted such that the length at which this straight line is in contact with the curve is the longest at the low-temperature region of the storage modulus G′ curve, which has a plateau shape. The virtual straight line (ii) is a virtual curve plotted such that the length this straight line is in contact with the curve is the longest at the middle-temperature region of the storage modulus G′ curve, which has a shape similar to a falling straight line.

The temperature at which a peak point of loss modulus G″ (unit: MPa) appears refers to, as illustrated in FIG. 4, a temperature at a point (b) at which a value of the loss modulus G″ measured as a function of temperature is the greatest. The temperature at which a peak point of tan δ appears refers to, as illustrated in FIG. 4, a temperature at a point (c) at which a value of tan measured as a function of temperature is the greatest.

The temperature at which an inflection point of storage modulus G′ (unit: MPa) appears may be in a range of about −35° C. to about 30° C., the temperature at which a peak point of loss modulus G″ (unit: MPa) appears may be in a range of about −30° C. to about 25° C., and the temperature at which a peak point of tan δ appears may be in a range of about −30° C. to about 30° C. The temperature at which an inflection point of storage modulus G′ (unit: MPa) appears may be in a range of, for example, about −35° C. to about 20° C., about −35° C. to about 10° C., about −35° C. to about 0° C., or about −35° C. to about −10° C. When the inflection point of the storage modulus G′ appears at a temperature lower than −35° C., the normal force is reduced, and when the inflection point of the storage modulus G′ appears at a temperature exceeding 30° C., the normal force is likely to be excessively increased.

The temperature at which a peak point of loss modulus G″ appears may be in a range of, for example, about −30° C. to about 20° C., about −30° C. to about 5° C., about −30° C. to about 0° C., or about −30° C. to about −5° C. When the peak point of the loss modulus G″ appears at a temperature lower than −30° C., deformation may easily occur in the paddle blades.

The temperature at which a peak point of tan δ appears may be in a range of, for example, about −30° C. to about 20° C., about −30° C. to about 10° C., about −30° C. to about 5° C., about −30° C. to about 0° C., or about −30° C. to about −5° C. When the peak point of tan δ appears at a temperature lower than −30° C., molecular movements in an amorphous region of a polymer material constituting the paddle blades becomes more active, and thus deformation may easily occur. When the peak point of tan δ appears at a temperature greater than 30° C., the rigidity of the paddle blades becomes too high such that the normal force acting on the surface of paper is easily weakened.

The present disclosure have confirmed that, when a paddle device including paddle blades having the above-described controlled properties is used, good paddling operability may be obtained for a long period of time even in an inkjet-printing-type imaging apparatus. Therefore, when the paddle device is used in an inkjet-printing-type imaging apparatus, sheets of paper may be stably aligned for a long period of time without the occurrence of curling or wrinkling of the paper, or abnormal damage to the paper. Accordingly, finishing operations such as compiling, stacking, punching, stapling, and the like may be smoothly performed.

When the paddle blades 211 and 212 fail to satisfy both the above-described mechanical properties and the viscoelastic properties, as can be seen from comparison between the following examples and comparative examples, it is difficult to satisfactorily use these paddle blades in an inkjet-printing-type imaging apparatus. In particular, when these paddle blades are used in an inkjet-printing-type imaging apparatus for a long period of time, elasticity of the paddle blades is relatively rapidly reduced over time and plasticity thereof is relatively rapidly increased, and thus the normal force and pulling force acting on the surface of paper are dramatically reduced, and accordingly, paper alignment becomes poor. As a result, paper curling, paper wrinkles, or abnormal damage to paper may easily occur. Thus, when such an inkjet-printing-type imaging apparatus is used for a long time period, it is difficult to smoothly perform finishing operations such as compiling, stacking, punching, stapling, and the like.

The paddle blades 211 and 212 may include a polyurethane rubber or a polyurethane elastomer. In another example, the paddle blades 211 and 212 may be made of a polyurethane rubber or a polyurethane elastomer as a main material. In another example, the paddle blades 211 and 212 may include a polyurethane rubber or a polyurethane elastomer. In another example, the paddle blades 211 and 212 may be made of a polyurethane rubber or a polyurethane elastomer.

The polyurethane rubber or the polyurethane elastomer may be obtained by preparing a urethane prepolymer and then further reacting the urethane prepolymer with a curing agent. The urethane prepolymer may be obtained by reacting a first polyol compound containing two or more hydroxyl groups per molecule with an aromatic polyisocyanate compound containing, per molecule, two or more isocyanate groups, for example, two to four isocyanate groups, for example, two to three isocyanate groups. The urethane prepolymer may be produced by a reaction between the first polyol compound and the aromatic polyisocyanate compound in such amounts that a ratio of equivalents of the hydroxyl groups of the first polyol compound to the isocyanate groups of the aromatic polyisocyanate compound ranges from about 1:1.1 to about 1:5. When the ratio of equivalents thereof is less than 1:1.1, a hydroxyl group-terminated urethane prepolymer may be easily obtained, and when the ratio of equivalents thereof is greater than 1:5, it may be difficult to increase a molecular weight of the urethane prepolymer.

In preparation of the urethane prepolymer, the first polyol compound may be a polyether-based polyol, a polyester-based polyol, a polyetherester polyol, or a mixture thereof, have a number average molecular weight of about 1,000 to about 8,000, and contain, for example, 2 to 6 hydroxyl groups, for example, 2 to 5 hydroxyl groups. For example, the first polyol compound may be a polyether-based polyol, such as a polyethylene glycol, a polypropylene glycol, a polybutylene glycol, or the like obtained by addition polymerization of ethylene oxide, propylene oxide, tetrahydrofuran (THF), or the like using, as an initiator, an alcohol compound containing two to six hydroxyl groups, for example, two to five hydroxyl groups, such as ethylene glycol, glycerol, butane diol, trimethylol propane, pentaerythritol, or the like. A polyester-based polyol such as ethylene glycol adipate, dihydroxy-terminated polyethylene adipate, or the like may also be used as the first polyol compound. In addition, a modified polyol such as an acryl-modified polyol, a silicone-modified polyol, or the like may be used as the first polyol compound.

Examples of the aromatic polyisocyanate compound which may be used in preparing a urethane prepolymer include toluene diisocyanate (TDI), 4,4′-methylene diphenyl diisocyanate (MDI), xylene diisocyanate (XDI), isophorone diisocyanate (IPDI), polymethylene polyphenyl polyisocyanate, and the like. In addition, a mixture or modified product of these compounds may be used as the aromatic polyisocyanate compound. Further, an aliphatic diisocyanate such as hexamethylene diisocyanate (HDI) or the like may also be used.

As described above, when the urethane prepolymer is allowed to further react with a curing agent, a polyurethane rubber or elastomer may be obtained.

The curing agent may include a second polyol compound containing two or more hydroxyl groups per molecule. The second polyol compound may be the same as the first polyol compound. In addition, the curing agent may further include a multifunctional chain extender containing, per molecule, two or more of hydroxyl groups, amino groups, or a combination of these, a catalyst for catalyzing an addition reaction between isocyanate terminal groups of the urethane prepolymer and hydroxyl groups of the second polyol compound, and a plasticizer.

As the second polyol compound used in the curing agent, the aforementioned examples of the first polyol compound used in preparing the urethane prepolymer as a main component may also be used.

A ratio of equivalents of isocyanate groups of the urethane prepolymer to a sum of hydroxyl groups of the second polyol compound and functional groups of the chain extender in the curing agent may range from about 1:0.5 to about 1:5.0. When the ratio of equivalents thereof is less than 0.5, the polyurethane may not be sufficiently cured, and when the ratio of equivalents thereof is greater than 5.0, the polyurethane may have excessively high hardness.

As the chain extender, water, a low-molecular-weight multifunctional alcohol such as ethylene glycol, 1,2-propanediol, 1,3-propanediol, 1,2-butanediol, 1,3-butanediol, 1,4-butanediol, glycerol, trimethylol propane, or the like, and/or a multifunctional polyamine compound such as hydrazine, ethylene diamine, propylene diamine, tetramethylene diamine, pentamethylene diamine, hexamethylene diamine, 1,2-dimethylethylene diamine, 2-methylpentamethylene diamine, diethylenetoluene diamine, 4,4′-diaminodiphenylether, 2,3-diaminotoluene, 2,4- or 4,4′-diaminodiphenylmethane, 1,3- or 1,4-diphenyldiamine, naphthalene-1,5-diamine, 1,3-dimethyl-2,4-diaminobenzene, 1,3,5-triethyl-2,4-diaminobenzene, 3,3′,5,5′-tetramethyl-4,4′-diaminodiphenylmethane, 3,3′-dimethyl-4,4′-diaminodiphenylmethane, 3,3′-dichloro-4,4′-diaminodiphenylmethane, 4,4′-(1,3-phenyleneisopropylidene)bisaniline, 4,4′-(1,4-phenyleneisopropylidene)bisaniline, or the like may be used, and these may be used alone or a mixture of two or more of these materials may be used. The amount of the chain extender may range from about 0.5 wt % to about 10 wt %, for example, about 1 wt % to about 5 wt %, with respect to a total weight of reactants, in view of molecular weight control of the polyurethane.

As a curing catalyst for catalyzing the addition reaction, tin acetate, dibutyltin acetate, dibutyltin dilaurate, dioctyltin dilaurate, tetrabutyl titanate, dibutyltin maleate, stannous octoate, lead octoate, N′-tetramethyl-1,3-butanediamine, or the like may be used, and these materials may be used alone or a mixture of two or more of these materials may be used. The amount of the curing catalyst may range from about 0.05 wt % to about 5 wt %, for example, about 1 wt % to about 3 wt %, with respect to the total weight of reactants, in view of workability and a curing rate.

When reacting the urethane prepolymer with the curing agent, an acid for controlling a reaction rate by controlling the pH of a reaction system may be further used. When mixing the urethane prepolymer with the curing agent, pH may be controlled to about 4 to about 6.5. When the pH is less than 4 or greater than 6.5, the reaction rate may become slower.

Non-limiting examples of the plasticizer include phthalates such as dibutyl phthalate, dioctyl phthalate, and butyl benzyl phthalate; adipates such as dibutyl adipate, dioctyl adipate, and diethylhexyl adipate; and octoates such as lead octoate, and these materials may be alone or a mixture of two or more of these materials may be used. The amount of the plasticizer may range from about 0 wt % to about 10 wt %, for example, about 0 wt % to about 5 wt %, about 0 wt % to about 3 wt %, or about 0 wt % to about 2 wt %, with respect to the total weight of reactants including the main component including a polyisocyanate compound used for polyurethane synthesis, and the curing agent. When the amount of the plasticizer is greater than 10 wt % with respect to the total weight of the main component and the curing agent, mechanical properties of the polyurethane may deteriorate, and thus durability thereof may be rapidly reduced.

According to another example of the present disclosure, a finisher device includes a paddle device according to an example of the present disclosure.

According to another example of the present disclosure, an imaging apparatus includes a paddle device according to an example of the present disclosure or a finisher device according to another example of the present disclosure.

Hereinafter, the present disclosure will be described in further detail with reference to the following examples. However, these examples are provided for illustrative purposes and are not intended to limit the scope of the present disclosure.

### Examples 1 to 3 and Comparative Examples 1 to 6: Manufacture of Paddle Blades

As shown in Table 1 below, 4,4′-diphenylmethane diisocyanate (4,4′-MDI) with a NCO content of 10.4% to 16.9% was added to a mixture of ethylene glycol adipate and polyethylene adipate in a mixing ratio of 100: 50-82, and allowed to react in a nitrogen atmosphere at about 80° C. for about 3 hours to obtain a NCO group-terminated urethane prepolymer (main component).

1,4-butanediol and trimethylol propane as curing agents and a plasticizer were weighed in parts by weight, as shown in Table 1, and added to the NCO group-terminated urethane prepolymer heated at about 80° C., and then mixed by spinning mixing screws at a high speed at about 2,000 rpm for about 1 minute, followed by a defoaming process in a vacuum to prevent air bubbles from being generated. The resulting reactive composition was subjected to centrifugal molding for paddle blades, whereby the reactive composition was added in a predetermined amount onto side walls of a centrifugal mold to fabricate polyurethane rubber sheet having a thickness of about 1.8 mm. The mold was heated to about 120° C. and spun at about 1,200 rpm for about 40 minutes to cure the reactive composition. The cured reaction product, i.e., polyurethane rubber, was taken out of the mold, and then maintained for aging at room temperature for 4 days to allow the NCO terminal groups remaining in trace amounts on a surface of the polyurethane rubber to react with moisture in air.

The resulting polyurethane elastic sheet was cut into a rectangular shape. Various characteristics of the paddle blades manufactured according to Examples 1 to 3 and Comparative Examples 1 to 6 were evaluated, but to measure a compiling force, each paddle blade was installed in a finisher device of a PWA inkjet printer manufactured by HP Co., Ltd.

TABLE 1

| | NCO group-terminated urethane | | | | | | | |
|---|---|---|---|---|---|---|---|---|
| | prepolymer (main component) | | | | | | | |
| | Mixing | Mixing | | Curing agent | | | | |
| | amount of | amount of | | 1,4- | | Amine | | |
| | ethylene | polyethylene | | butane | Trimethylol | curing | | |
| | glycol | adipate | | diol | propane | agent* | | |
| | adipate | (Mn = 2,000) | NCO %*** | (parts | (parts | (parts | Plasticizer | |
| | (parts by | (parts by | of the main | by | by | by | | Amount^{#} |
| | weight) | weight) | component | weight) | weight) | weight) | Type | (wt %) |
| Example 1 | 100 | 73 | 13.7% | 6.74 | 4.12 | — | — | — |
| Example 2 | 100 | 67 | 10.9% | 7.85 | 4.75 | — | Butyl | 2 |
| | | | | | | | benzyl | |
| | | | | | | | phthalate | |
| Example 3 | 100 | 79 | 16.9% | 6.52 | 3.95 | trace** | Di-2- | 5 |
| | | | | | | | ethylhexyl | |
| | | | | | | | adipate | |
| Comparative | 100 | 50 | 16.4% | 5.03 | 3.03 | trace | Butyl | 20 |
| Example 1 | | | | | | | benzyl | |
| | | | | | | | phthalate | |
| Comparative | 100 | 55 | 13.7% | 5.44 | 3.31 | — | Di-2- | 20 |
| Example 2 | | | | | | | ethylhexyl | |
| | | | | | | | adipate | |
| Comparative | 100 | 62 | 13.7% | 6.92 | 4.15 | — | Di-2- | 20 |
| Example 3 | | | | | | | ethylhexyl | |
| | | | | | | | adipate | |
| Comparative | 100 | 82 | 14.5% | 8.42 | 5.14 | — | Butyl | 30 |
| Example 4 | | | | | | | benzyl | |
| | | | | | | | phthalate | |
| Comparative | 100 | 76 | 10.4% | 7.78 | 4.88 | trace | Di-2- | 30 |
| Example 5 | | | | | | | ethylhexyl | |
| | | | | | | | adipate | |
| Comparative | 100 | 79 | 11.7% | 8.36 | 5.06 | — | Di-2- | 30 |
| Example 6 | | | | | | | ethylhexyl | |
| | | | | | | | adipate | |

*N′-tetramethyl-1,3-butanediamine,
**Less than 300 weight ppm on the total weight of the polyurethane;
***Percentage (%) of isocyanate groups at end groups of the obtained urethane prepolymer assuming that the total weight of the main component (ethylene glycol adipate + polyethylene adipate + MDI) is 100; and
^{#}% with respect to the total weight of reactants.

Measurement of Normal Load Variation

An initial normal load in a range of about 10 gf to about 15 gf was applied to an end portion of each of paddle blades of Examples 1 to 3 and Comparative Examples 1 to 6 having a thickness of about 1.8 mm in a direction perpendicular to the end portion using a self-fabricated measurement jig at room temperature. Subsequently, a normal load applied to the end portion of each paddle blade over elapsed time was measured using the jig.

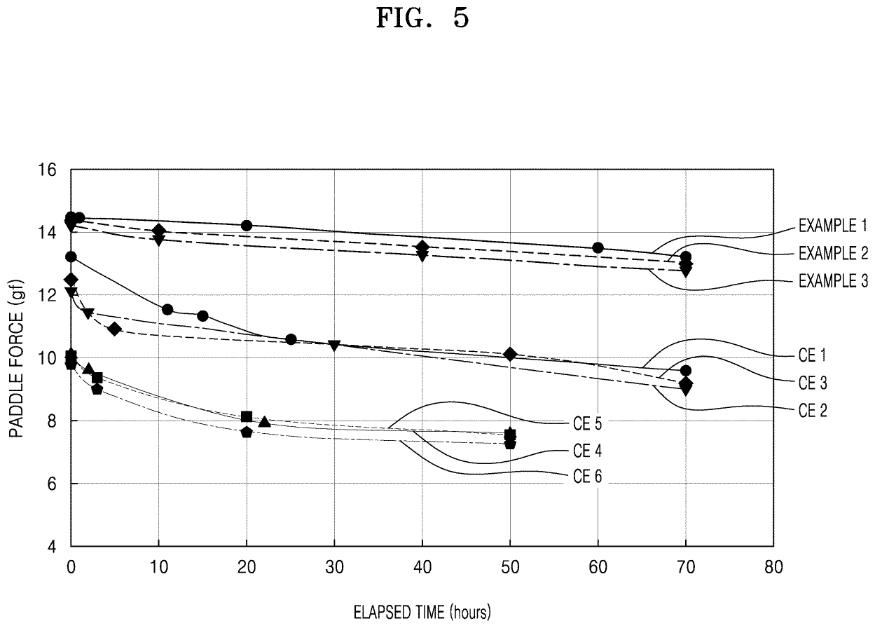

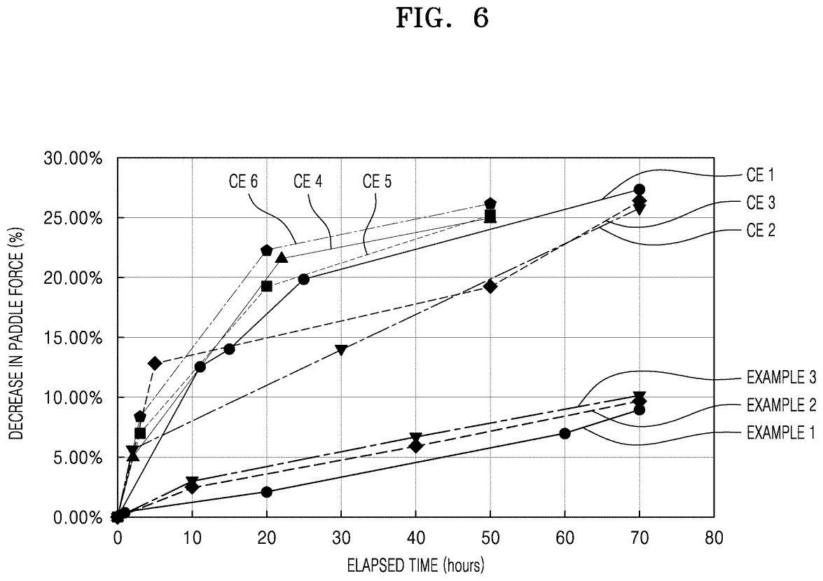

FIG. 5 illustrates results of measuring changes in paddle force (normal force) applied to end portions of the paddle blades of Examples 1 to 3 and Comparative Examples 1 to 6 (abbreviated as CE 1 to CE 6 in FIGS. 5 and 6) over time. FIG. 6 illustrates percentage of decreases in paddle force (normal force) applied to end portions of the paddle blades of Examples 1 to 3 and Comparative Examples 1 to 6 over time.

Referring to FIG. 5, it can be confirmed that, while the paddle blades of Examples 1 to 3 according to the present disclosure exhibited a variation in paddle force, i.e., normal force or normal load, of 0.03 gf/hr or less after 70 hours, the paddle blades of Comparative Examples 1 to 6 exhibited a variation in paddle force, i.e., normal force or normal load, of much greater than 0.03 gf/hr after 70 hours.

Referring to FIG. 6, it can be confirmed that, while the paddle blades of Examples 1 to 3 according to the present disclosure exhibited a decrease in paddle force (normal force) of 10% or less after 70 hours, the paddle blades of Comparative Examples 1 to 3 exhibited a decrease in paddle force (normal force) of much greater than 10%, i.e., 25% or more after 70 hours. In the cases of Comparative Examples 4 to 6, the amount of deformation was excessively high, and thus tests were stopped at 50 hours.

Table 2 shows paddle force values at t=0 hr and t=70 hr in the graph of the samples of Examples 1 to 3 and Comparative Examples 1 to 3 of FIG. 5.

TABLE 2

| | | | Paddle |
|---|---|---|---|
| | | | force |
| | Paddle | Paddle | variation |
| | force | force | after 70 |
| | at 0 hr | at 70 hr | hours |
| | (gf) | (gf) | (gf/hr) |
| Example 1 | 14.5 | 13.2 | 0.018 |
| Example 2 | 14.4 | 13.0 | 0.020 |
| Example 3 | 14.2 | 12.7 | 0.021 |
| Comparative | 13.2 | 9.59 | 0.051 |
| Example 1 | | | |
| Comparative | 12.1 | 8.98 | 0.044 |
| Example 2 | | | |
| Comparative | 12.5 | 9.2 | 0.047 |
| Example 3 | | | |

Deformation Measurement for End Portion of Paddle Blade

By using a self-fabricated in-house measurement jig, each of the paddle blades of Examples 1 to 3 and Comparative Examples 1 to 6 having a thickness of about 1.8 mm was repeatedly rubbed against a surface of paper by making the paddle blade rotate at a speed of 1,600 pulses per second (pps) or 6,000 pps two or three times within 2.41 seconds while an initial normal load of about 10 gf to about 15 gf was applied to an end portion of each paddle blade in a direction perpendicular to the end portion at room temperature. Subsequently, an amount of deformation of the end portion of each paddle blade after 70 hours was measured using the jig, and the results thereof are shown in Table 3 below.

TABLE 3

| | Amount of |
|---|---|
| | deformation |
| | of end portion |
| | of paddle |
| | blade (mm) |
| Example 1 | 0.05 |
| Example 2 | 0.07 |
| Example 3 | 1.1 |
| Comparative | 3.1 |
| Example 1 | |
| Comparative | 2.1 |
| Example 2 | |
| Comparative | 5.2 |
| Example 3 | |
| Comparative | 6.2 |
| Example 4 | |
| Comparative | 6.1 |
| Example 5 | |
| Comparative | 6.5 |
| Example 6 | |

Referring to Table 3, it was confirmed that, while the paddle blades of Examples 1 to 3 according to the present disclosure had a deformation of 0.05 mm to 1.1 mm after 70 hours, which indicates excellent deformation resistance, the paddle blades of Comparative Examples 1 to 6 had a deformation of 2.1 mm to 6.5 mm, which is much higher than that of each of the cases of Examples 1 to 3.

Measurement of Storage Modulus, Loss Modulus, and tan δ

A temperature at which an inflection point of storage modulus G′ (unit: MPa) of a polyurethane rubber constituting each of the paddle blades of Examples 1 to 3 and Comparative Example 1 appears, a temperature at which a peak point of loss modulus G″ of each polyurethane rubber (unit: MPa) appears, and a temperature at which a peak point of tan δ of each polyurethane rubber appears were measured according to a sine wave oscillation method by using ARES measurement equipment provided with a dynamic mechanical analyzer (DMA) manufactured by Rheometric Scientific, Inc. under the following measurement conditions:
Measurement conditions: temperature ranging from about −100° C. to about 100° C., frequency: 10 Hz, strain of 0.03%, heating rate: 2° C./min, and initial strain of 0.03%;
Size of specimen: 3 mm×60 mm;
Grip gap: 20 mm;
Atmosphere: nitrogen atmosphere.

Table 4 summarizes the temperature at which an inflection point of storage modulus G′ (unit: MPa) of a polyurethane rubber constituting each of the paddle blades of Examples 1 to 3 and Comparative Example 1 appeared, the temperature at which a peak point of loss modulus G″ of each polyurethane rubber (unit: MPa) appeared, and the temperature at which a peak point of tan δ of each polyurethane rubber appeared.

TABLE 4

| | Temperature | | |
|---|---|---|---|
| | for | Temperature | |
| | inflection | for peak | |
| | point of | point | Temperature |
| | storage | of loss | for peak |
| | modulus | modulus | point |
| | G′ | G″ | of tanδ |
| Example 1 | −18 | −16 | −16 |
| Example 2 | −28 | −21 | −21 |
| Example 3 | −34 | −30 | −15 |
| Comparative | −45 | −41 | −34 |
| Example 1 | | | |

Compiling Force Measurement

The paddle blade of Example 1 was installed in a finisher device of a PWA inkjet printer manufactured by HP Co., Ltd and while a paddle thereof was rotated, a compiling force acting on the paddle blade was measured using a self-fabricated in-house measurement jig. Measurement was performed twice each for a height of 2 sheets of paper, a height of 33 sheets of paper, and a height of 65 sheets of paper.

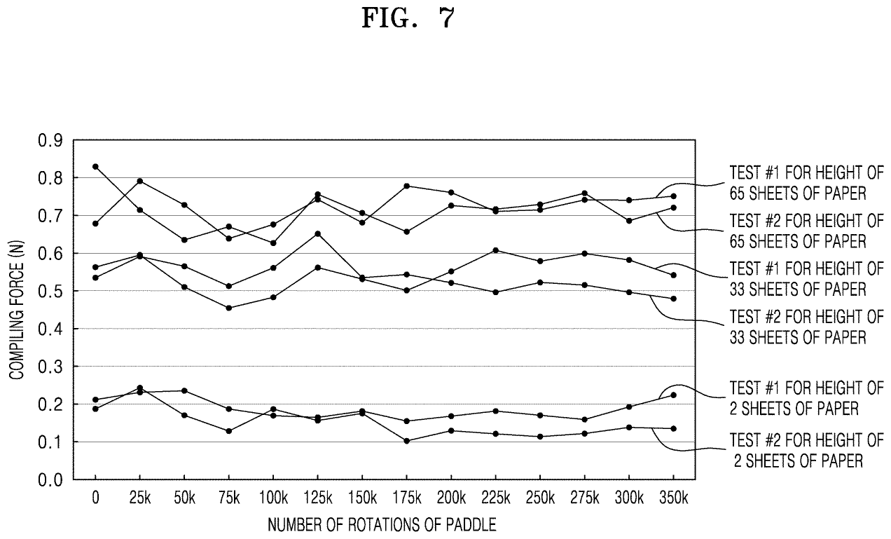

FIG. 7 is a graph recording changes in compiling force according to an increase in the number of rotations of a paddle for the paddle blade of Example 1

Referring to FIG. 7, it can be confirmed that, in the case of the paddle blade of Example 1, the compiling force is stably maintained until the paddle is rotated up to 350,000 times in all cases, when measured at the height of 2 sheets of paper, the height of 33 sheets of paper, and the height of 65 sheets of paper.

From the foregoing description, it can be confirmed that, when a paddle device including a paddle blade controlled so as to have mechanical and viscoelastic properties as defined in the following claims is used, finishing operations such as alignment, compiling, punching, stapling, and the like may be smoothly performed stably for a long time period without the occurrence of curling or wrinkling of the paper, or abnormal damage to the paper.

Although examples of the present disclosure have been described with reference to the specific examples and drawings, it will be obvious to those of ordinary skill in the art that various changes and modifications may be made from the foregoing description. For example, it will be understood that, even if the above-described techniques are performed in an order different from that of the described methods, and/or components described above, such as systems, structures, devices, circuits, and the like are coupled or assembled in a form different from that of methods described above, or are replaced or substituted with other components or equivalents thereto, appropriate results may be achieved.

What is claimed is:

1. A paddle device for a finisher device to align paper discharged from an imaging apparatus, the paddle device comprising:
a paddle drive shaft to be rotated by a paddle motor;
a rotation body having an installation hole, through which the paddle drive shaft is fitted into the rotation body; and
a paddle blade extending from the rotation body and having an end portion that is to contact the paper while the paddle blade is being rotated by the paddle drive shaft, to align the paper,
wherein the paddle blade has at least one property such that, when the paddle blade has a thickness of about 1 mm to about 4 mm,
when an initial normal load of about 10 gf to about 15 gf is applied to the end portion of the paddle blade in a direction perpendicular to the end portion of the paddle blade at room temperature, a variation in a normal load applied to the end portion of the paddle blade over time is about 0.03 gf/hr or less after about 70 hours of use has elapsed, and
when the paddle blade is repeatedly rubbed against a surface of paper by making the paddle blade rotate at a speed of 1,600 pulses per second (pps), or 6,000 pps two or three times within 2.41 seconds, while the initial normal load of about 10 gf to about 15 gf is applied to the end portion of the paddle blade at room temperature, an amount of deformation of the end portion of the paddle blade after about 70 hours of use has elapsed is about 2 mm or less.

2. The paddle device of claim 1, wherein, in a measurement test performed on the paddle blade through dynamic mechanical analysis using a free damped oscillation method, the dynamic mechanical analysis being conducted as a function of temperature at a temperature ranging from about −100° C. to about 100° C. in a nitrogen atmosphere and at a measurement frequency of 10 Hz, a heating rate of 2.0° C./min, and an initial strain of 0.03%, a temperature at which an inflection point of storage modulus G′ (unit: MPa) appears is in a range of about −35° C. to about 30° C., a temperature at which a peak point of loss modulus G″ (unit: MPa) appears is in a range of about −30° C. to about 25° C., and a temperature at which a peak point of tan δ appears is in a range of about −30° C. to about 30° C.,
wherein the storage modulus G′ and the loss modulus G″ satisfy following relationships:
complex modulus of elasticity G*=G′+iG″, and
tan δ=G″IG′, where
δ refers to an angle of G* with respect to a real axis in a complex plane.

3. The paddle device of claim 1, wherein the paddle blade comprises a polyurethane.

4. The paddle device of claim 3, wherein the paddle blade comprises a plasticizer in an amount of about 0 wt % to about 10 wt % with respect to a total weight of reactants used in synthesis of the polyurethane.

5. The paddle device of claim 1, wherein the paddle blade has a thickness of about 1 mm to about 3 mm.

6. The paddle device of claim 1, wherein the imaging apparatus is an inkjet-printing-type imaging apparatus.

7. A finisher device to align paper discharged from an imaging apparatus, the finisher device comprising:
a paddle device,
wherein the paddle device comprises:
a paddle drive shaft to be rotated by a paddle motor;
a rotation body having an installation hole, through which the paddle drive shaft is fitted into the rotation body; and
a paddle blade extending from the rotation body and having an end portion that is to contact the paper while the paddle blade is being rotated by the paddle drive shaft, to align paper,
wherein the paddle blade has at least one property such that, when the paddle blade has a thickness of about 1 mm to about 4 mm,
when an initial normal load of about 10 gf to about 15 gf is applied to the end portion of the paddle blade in a direction perpendicular to the end portion of the paddle blade at room temperature, a variation in a normal load applied to the end portion of the paddle blade over time is about 0.03 gf/hr or less after 70 hours of use has elapsed, and
when the paddle blade is repeatedly rubbed against a surface of paper by making the paddle blade rotate at a speed of 1,600 pulses per second (pps) or 6,000 pps two or three times within 2.41 seconds while the initial normal load of about 10 gf to about 15 gf is applied to the end portion of the paddle blade at room temperature, an amount of deformation of the end portion of the paddle blade after about 70 hours of use has elapsed is about 2 mm or less.

8. The finisher device of claim 7, wherein, in a measurement test performed on the paddle blade through dynamic mechanical analysis using a free damped oscillation method, the dynamic mechanical analysis being conducted as a function of temperature at a temperature ranging from about −100° C. to about 100° C. in a nitrogen atmosphere and at a measurement frequency of 10 Hz, a heating rate of 2.0° C./min, and an initial strain of 0.03%, a temperature at which an inflection point of storage modulus G′ (unit: MPa) appears is in a range of about −35° C. to about 30° C., a temperature at which a peak point of loss modulus G″ (unit: MPa) appears is in a range of about −30° C. to about 25° C., and a temperature at which a peak point of tan δ appears is in a range of about −30° C. to about 30° C.,
wherein the storage modulus G′ and the loss modulus G″ satisfy following relationships:
complex modulus of elasticity G*=G′+iG″, and
tan θ=G″/G′, where
δ refers to an angle of G* with respect to a real axis in a complex plane.

9. The finisher device of claim 7, wherein the paddle blade comprises a polyurethane.

10. The finisher device of claim 9, wherein the paddle blade comprises a plasticizer in an amount of about 0 wt % to about 10 wt % with respect to a total weight of reactants used in synthesis of the polyurethane.

11. The finisher device of claim 7, wherein the paddle blade has a thickness of about 1 mm to about 3 mm.

12. The finisher device of claim 7, wherein the imaging apparatus is an inkjet-printing-type imaging apparatus.

13. An imaging apparatus comprising:
a finisher device to align paper discharged from the imaging apparatus, the finisher device comprising a paddle device,
wherein the paddle device comprises:
a paddle drive shaft to be rotated by a paddle motor;
a rotation body having an installation hole, through which the paddle drive shaft is fitted into the rotation body; and
a paddle blade extending from the rotation body and having an end portion that is to contact the paper while the paddle blade is being rotated by the paddle drive shaft, to align paper,
wherein the paddle blade has at least one property such that, when the paddle blade has a thickness of about 1 mm to about 4 mm,
when an initial normal load of about 10 gf to about 15 gf is applied to the end portion of the paddle blade in a direction perpendicular to the end portion of the paddle blade at room temperature, a variation in a normal load applied to the end portion of the paddle blade over time is about 0.03 gf/hr or less after about 70 hours of use has elapsed, and
when the paddle blade is repeatedly rubbed against a surface of paper by making the paddle blade rotate at a speed of 1,600 pulses per second (pps) or 6,000 pps two or three times within 2.41 seconds while the initial normal load of about 10 gf to about 15 gf is applied to the end portion of the paddle blade at room temperature, an amount of deformation of the end portion of the paddle blade after about 70 hours of use has elapsed is about 2 mm or less.

14. The imaging apparatus of claim 13, wherein, in a measurement test performed on the paddle blade through dynamic mechanical analysis using a free damped oscillation method, the dynamic mechanical analysis being conducted as a function of temperature at a temperature ranging from about −100° C. to about 100° C. in a nitrogen atmosphere and at a measurement frequency of 10 Hz, a heating rate of 2.0° C./min, and an initial strain of 0.03%, a temperature at which an inflection point of storage modulus G′ (unit: MPa) appears is in a range of about −35° C. to about 30° C., a temperature at which a peak point of loss modulus G″ (unit: MPa) appears is in a range of about −30° C. to about 25° C., and a temperature at which a peak point of tan δ appears is in a range of about −30° C. to about 30° C.,
wherein the storage modulus G′ and the loss modulus G″ satisfy following relationships:
complex modulus of elasticity G*=G′+iG″, and
tan δ=G″/G′, where
δ refers to an angle of G* with respect to a real axis in a complex plane.

15. The imaging apparatus of claim 13, wherein the paddle blade comprises a polyurethane.
